(19) United States
(12) Patent Application Publication
(10) Pub. No.: US 2013/0206755 A1
(43) Pub. Date: Aug. 15, 2013

(54) CONTAINER

(71) Applicant: Martin Myerscough, Suffolk (GB)

(72) Inventor: Martin Myerscough, Suffolk (GB)

(73) Assignee: Green Bottle Limited, Esher (GB)

(21) Appl. No.: 13/697,265

(22) PCT Filed: May 10, 2011
(86) PCT No.: PCT/GB2011/000713

§ 371 Date: Feb. 7, 2013

(30) Foreign Application Priority Data
May 10, 2010 (GB) 1007788.1

(51) Int. Cl. B65D 1/40; B29D 22/00

(52) U.S. Cl. CPC B65D 1/40; B29D 22/003
USPC 220/62.11; 264/516; 156/213

(57) ABSTRACT

Container and method of forming a container comprising an inner liner and an outer shell by providing an open shell that is closeable to provide the outer shell, vacuum forming the liner with a shape conforming generally to at least a portion of the inner volume of the shell from at least one film, positioning the formed liner in the open shell and closing the shell.

### FIELD OF THE INVENTION

The present invention relates to a package and to a method of forming a package.

### BACKGROUND TO THE INVENTION

There is a general environmental desire to reduce the amount of waste generated, and to re-use or recycle waste materials where possible. A particular concern is the amount of material used to create packaging, and the problems associated with the recycling of packaging materials.

In our earlier International Patent Application No. PCT/GB2006/005434 we disclose a container that is able to achieve these desires. The disclosed container comprises a hollow shell defining the container body and including a dispensing aperture. A bag or liner is provided within the shell. The bag or liner is made from a material suitable for containing the intended contents of the container, for example being formed from a moisture resistant or waterproof material where the container is intended to contain liquid. With the container described in our earlier application, the main part of the container, and in particular the part that provides structural stability and integrity, can be formed from materials that are recycled, recyclable and/or biodegradable, and which need not be normally suited for containing the intended contents of the container. The only part of the container that needs to be formed from material suited to containing the intended content of the container is the bag or liner. Accordingly, the container described in our earlier application requires less material that is suited for containing the intended content of the container, and is therefore more environmentally friendly than other containers. Further, as the shell and bag or liner can be separated and disposed of separately, the recycling or other processing of the used container is better than prior containers.

A potential problem with providing a bag or liner within a hollow shell is the insertion of the bag or liner into the shell. This is particularly the case if the bag or liner is inserted into the hollow shell through the dispensing aperture, since this aperture is generally of a smaller dimension than that of the inside of the container. This means that the bag or liner must be flexible, and must be folded or otherwise reduced in size to enable this to be loaded into the interior of the hollow shell. Once loaded, the bag or liner must be opened to allow the contents to be provided in the container. When doing so, there is a risk that the bag or liner may remain folded or twisted within the shell, and therefore that the internal volume of the bag or liner for containing products may not be as great as intended. This may result in the container overflowing during filling, or not containing the required volume of contents.

### SUMMARY OF THE INVENTION

According to a first aspect of the present invention there is provided a method of forming a container comprising an inner liner and an outer shell. The method comprises:
providing an open shell that is closeable to provide the outer shell having an inner volume defined by the inner walls of the shell;
providing a film;
heating the film;
vacuum forming the film to form a liner having a shape conforming generally to at least a portion of the inner volume of the shell;
positioning the liner in the open shell; and
closing the shell around the formed liner.

By forming the hollow shell as an open shell, and positioning the liner in the open shell before closing the shell around the liner, it is relatively simple to locate the liner within the shell, especially compared to loading a bag or liner through a relatively small dispensing opening of the shell after the shell has been formed. In particular, loading the liner into the open shell provides a large opening to receive the liner, and allows any required repositioning of the liner. Further, this allows the liner to be formed to a desired shape, rather than requiring the liner to be flexible as would be required if the liner were introduced into the shell through a smaller opening, such as a dispensing aperture. This helps ensure that the liner does not become creased, twisted or otherwise deformed in such a way that its internal volume may not correspond to the intended internal volume which may result in the incomplete or unsatisfactory filling of the container.

Furthermore, by forming the liner with a shape conforming generally to at least a portion of the inner wall of the shell, the liner can be arranged such that at least part, and preferably the majority, of the outer surface of the liner will be in contact with the inner surface of the shell when the shell is closed. Such contact between the outer surface of the liner and the inner surface of the closed shell is advantageous as it allows for the weight of the content within the liner to be carried by the shell. This additionally allows for thinner liners to be used than would otherwise be possible. Thinner liners require less material and can therefore be cheaper to produce and have enhanced environmental benefits.

Vacuum forming the film to form the liner is particularly advantageous as this can ensure that liners can be formed consistently with minimum thickness, reducing the amount of material required for the liner, while still giving the desired properties to contain the intended contents of the container. In particular, vacuum forming techniques can be used to form liners having a final thickness of less than 50 microns reliably and consistently which are able to contain the contents when provided within a hollow shell.

The liner does not need to conform to all parts of the interior of the hollow shell. For example, the hollow shell may include portions defining a handle or other desired shaping which are not intended to contain contents, and accordingly the liner need not conform to these parts of the shell. In general, it is advantageous for the main body of the liner to conform generally to the main body of the hollow shell.

In a preferred example, the liner is formed from a multilayer film. Such a film can provide desirable properties for the liner suited to the intended contents of the container. For example, different layers may provide different properties to the liner, for example providing moisture resistance, resisting permeation of gases, vapours and smells. This can apply to stop gases, vapours, liquids etc. passing either to the contents, or escaping from the contents. Where the film is a multilayer film, vacuum forming of the liner is particularly advantageous as this can avoid the layers of the film separating as the film is shaped to form the liner.

The layers of the multilayer film are preferably laminated.

The layers may include one or more layers of polyethylene (PE), low-density polyethylene (LDPE), high-density polyethylene (HDPE), ethylene vinyl alcohol (EVOH) and layers containing aluminium.

Preferably, at least one of the layers comprises a barrier layer that will act to prevent or restrict migration of gas or other fluid through the liner. This can be beneficial when wanting to prevent contamination or degradation of the contents of the container, for example by preventing or reducing migration of scents through the liner and thereby out of the container, or preventing ingress of oxygen. This can also prevent contaminants such as ink vapours, migrating from the shell into the contents. Barrier layers may comprise or contain ethylene vinyl alcohol, which can act as an oxygen barrier and therefore help to prevent the oxidation of consumable products, such as foods or beverages contained within the container, and/or aluminium which is particularly beneficial where the contents include wine, carbonated beverages and fruit based beverages.

In a preferred case, the liner can be formed from at least three layers, with two outer coating layers sandwiching a barrier layer. Possible outer coating layers could include PE, LDPE or HDPE, whilst possible barrier layers could include EVOH or aluminium. In a particularly preferred example, the liner material is formed of at least two layers of polyethylene with a layer of ethylene vinyl alcohol located between the two polyethylene layers. The ethylene vinyl alcohol layer may have a thickness of less than 10 microns, preferably around 4 microns.

The overall thickness of the film is preferably no greater than 80 microns, and more preferably no greater than 50 microns. By reducing the thickness of the film, the overall amount of material required to form the liner is reduced, thereby reducing manufacturing costs. During vacuum forming, the film will be stretched and therefore the thickness of the walls of the liner will be less than the thickness of the original film. It is preferred that the thinnest portions of the walls of the formed liner, which would typically occur near corners, should not be less than 25 microns, although it will be appreciated that this may be dependent upon the material of the liner and the intended contents. Vacuum forming is particularly advantageous over other forming methods when forming liners of such low thicknesses.

Advantageously, the liner is formed from two films, such as two multilayer films, each of which is heated and vacuum formed to form a portion of the liner, and which are joined together, once formed, to form the liner. In this case, the two portions may be joined by welding, by an adhesive or by any other suitable means. Forming the liner in two parts which are joined together subsequently may ease the manufacturing process.

The step of providing an open shell may include providing portions of the shell in a unitary item, which can be folded with respect to each other to form the hollow shell. In this case, the portions of the shell may be folded around one or more hinges, such as creased, scored or thinned portions, to form the hollow shell. As a particular example, the unitary item may comprises two halves of the body of the hollow shell joined along one side by a web about which the two halves can be pivoted to form the hollow shell. In an alternative, the step of providing an open shell may include providing multiple, separate, parts of the hollow shell which are closed by joining the parts together. In one example, the shell may be formed from two parts which are joined together around an outer edge. In this case, joining the two parts together may involve placing the first part adjacent to the second part, and folding one or more flanges on the second part around the outer surface of the first part.

The parts of the shell are preferably connected together using an adhesive, such as a hot melt adhesive. In this case, the hot melt adhesive may be provided on a joining surface or flange on one part of the shell to attach the joining surface or flange to the other part of the shell. Since the hot melt adhesive may melt or otherwise damage the liner if it comes into contact with the liner, the adhesive is preferably applied to the outer surface of the shell and/or the joining surface or flange after closing the parts of the shell to join the parts of the shell. In this way, the liner is enclosed by the shell before the adhesive is applied, and therefore the adhesive cannot come into contact with the liner and damage this.

Advantageously, the shell is formed from a pulp material, for example from wood pulp or paper pulp, or from hemp. In this case, the shell may be moulded. By moulding the shell, the shell can be formed with planar and/or curved faces. This enables the container to be shaped as desired for aesthetic and functional purposes. For example, it is possible to provide containers having an overall shape that is particularly attractive, or which is designed to relate to the product to be contained in the container for identification purposes, or may be provided with a raised, recessed or embossed pattern or image. It is also possible to shape the container so that this may be more easily held and manipulated by a user, for example to provide portions for gripping the container during dispensing of the contents. It is, for example, possible to provide handle portions that may be held by the user when dispensing the contents of the container. Also shaping the body allows strength and stiffness to be added and thinner material thicknesses can therefore be used, reducing costs. The shell could also be moulded from other material, or may be formed in other ways, for example by folding or assembling of plain sheets of material.

It is preferred that the hollow shell is provided with a moisture resistant covering on the outer surface. This is particularly beneficial where the container may be left in a wet or damp environment in which the structure of the container could be destroyed by moisture. For example, where the container is intended to hold a product that must be kept at a low temperature, there is the risk of condensation forming on the outside of the container if the container is moved into a warm environment. In this case, the condensation could damage the container, and in particular its structural rigidity, if the outer surface were not moisture resistant. Where the outer surface of the hollow shell is covered with a moisture resistant coating, it is preferred that this coating is easily removable from the hollow shell for separate disposal and/or recycling. In one embodiment, example, the shell may be treated, for example using seize, to give the required moisture resistant properties. The bottom of the shell may also be coated with water resistant material, such as latex or PVA. This is beneficial as this provides protection against disintegration of the shell if the container is standing in a pool of water or other liquid.

The shell may include an accelerator that helps promote the degradation of the shell after use. Alternatively or additionally, additives may be included which help breakdown the intended content of the container—for example where the container is to carry oil, an additive may be included in the liner and/or the shell which helps breakdown oil over time, increasing the recyclable properties of the container.

In one example, the liner may be positioned in the open shell such that a part of the liner will extend though a dispensing aperture of the shell when the open shell is closed. By locating the liner to extend through a dispensing opening of the shell, contents contained within the liner within the shell of the container can be dispensed through the dispensing aperture without coming into contact with the shell itself. This permits a greater choice of materials from which the shell can be formed as there is no requirement for the material of the shell to be compatible with the intended contents of the container.

In this case, the liner may be formed with a collar or neck portion that can be located to extend through a dispensing aperture of the shell. The collar or neck portion may be used for sealing the container, for example by including features for enabling connection of a separate stopper or cap. For example, the collar or neck portion may have an external screw thread for receiving a screw cap.

The collar or neck may be formed integrally with the remainder of the liner, or may be formed as a separate component which is joined to the remainder of the liner. For example, the separate component may be joined to the remainder of the liner by welding or by an adhesive.

Where the liner is formed from two films, for example two multilayer films, the separate component forming the collar or neck is preferably located between the two vacuum formed films and attached between the two vacuum formed films when these are joined together. Alternatively, the collar or neck may be attached to one of the films before or after this is joined to the other film.

The or each film, such as a multilayer film, is preferably heated using radiation, such as infrared energy, that heats the films without contact. This is advantageous compared to contact heaters, for example hot air blowers, that may either damage the surface of the film due to contact, or which, in the case of multilayer films, may heat the outer layers of the film more than the inner layers of the film, which may cause separation or delamination of the layers of the film. A suitable source of radiation is an infrared lamp. Where two films are provided to form the liner, the films may be heated simultaneously with a single radiation source.

The material should be heated to a temperature beyond its slip point but below its melting point, to obtain a desirable flexibility such that it conforms more easily to a vacuum forming tool. Where the starting material is formed from a film having two or more laminate layers of different compositions, the material should be heated to a temperature which lies between the slip points and melting points of the laminate layers.

The liner may be formed to have a shape slightly larger than at least a portion of the internal volume of the shell. This is advantageous as it ensures that the weight of the contents of the container within the liner will be carried by the shell. This has also been found to help avoid the contents spilling in the event of an impact on the container, for example when the container is dropped. Such an impact may cause the shell to rupture. In this case, where the liner is larger than the internal volume of the shell, the liner can expand to its natural volume, damping the impact, and thereby avoiding rupture of the liner.

After use, the shell may be openable to allow the liner to be removed from the shell. This is useful where the liner is formed from a different material to the shell, and therefore must be recycled separately. By opening the shell and removing the liner, the two components of the container may be separated and disposed of separately. The shell may be opened by rupturing or tearing the shell. This can be assisted by providing a weakened portion, such as a preforated portion, and/or with a tear strip on the shell. Alternatively, the shell may be opened by splitting along the join between parts of the shell.

The method may further comprise securing the liner to the shell, for example by attaching the liner to the shell at least around a dispensing aperture of the shell. This helps ensure that the liner remains closely associated with the hollow shell at least around the dispensing aperture through which the contents of the container will be dispensed. This also helps ensure that the liner is not pulled further into the hollow shell than desired when the container is filled. In this case, the liner may be attached by an adhesive, by tape, or by shrink wrapping where the liner is heated to shrink this into contact with the outside of the shell around the dispensing opening. Where the liner includes a neck or collar portion, the neck of collar may include a flange that abuts against a surface of the shell to secure the liner to the shell. For example, the neck or collar may include a flange that rests on the outer surface of the hollow shell.

According to a further aspect of the present invention, there is provided a container formed in accordance with the method of the first aspect of the invention.

According to a further aspect of the present invention, there is provided a container comprising an outer shell and an inner liner, the outer shell comprising an open shell that is closeable to provide the outer shell having an inner volume defined by the inner walls of the shell, and the inner liner comprising a vacuum formed liner formed from a film having a shape conforming generally to at least a portion of the inner volume of the shell.

In this case, it is preferred that the shell is formed from a pulp material, for example from wood pulp or paper pulp, or from hemp.

The liner may be formed from a multilayer film comprising two or more layers of material. The multiple layers may be laminated together.

Examples of possible layers include polyethylene (PE), low-density polyethylene (LDPE), high-density polyethylene (HDPE). At least one of the layers is preferably a barrier layer, for example a layer containing or consisting of ethylene vinyl alcohol (EVOH) and/or aluminium.

In a preferred case, the liner is formed from at least three layers, with two outer coating layers sandwiching a barrier layer.

In a particularly preferred example, the liner material is formed of at least two layers of polyethylene with a layer of ethylene vinyl alcohol located between the two polyethylene layers. In this case, the ethylene vinyl alcohol layer may have a thickness of less than 10 microns, preferably around 4 microns.

The liner preferably includes a collar or neck portion that extends through an opening of the hollow shell to allow for filling of the container and/or dispensing of the contents of the container. In this case, the collar or neck portion may be integral with the remainder of the liner, or may be attached to the remainder of the liner, for example by welding or using an adhesive. The collar or neck portion may include a feature for connection of a cap or stopper to seal the container. For example the collar or neck may include a screw thread to receive a screw cap.

### BRIEF DESCRIPTION OF THE DRAWINGS

The present invention will now be described, by way of example only, with reference to the accompanying drawings, in which:

FIG. 1 shows a cross-section through a container according to the present invention;

FIG. 2 shows a cross-section through an open shell with formed liner for use in forming the container of FIG. 1;

FIG. 3 shows a cross-section through a container formed from the shell and liner of FIG. 2;

FIG. 4 shows a cross-section through an alternative open shell with formed liner for use in forming the container of FIG. 1;

FIG. 5 shows a cross-section through a container formed from the shell and liner of FIG. 4;

FIGS. 6A to 6C show steps in the formation of a liner;

FIG. 7 shows an example of a container according to the present invention; and

FIG. 8 shows a cross section though the open end of container including a liner with an insert.

### DETAILED DESCRIPTION

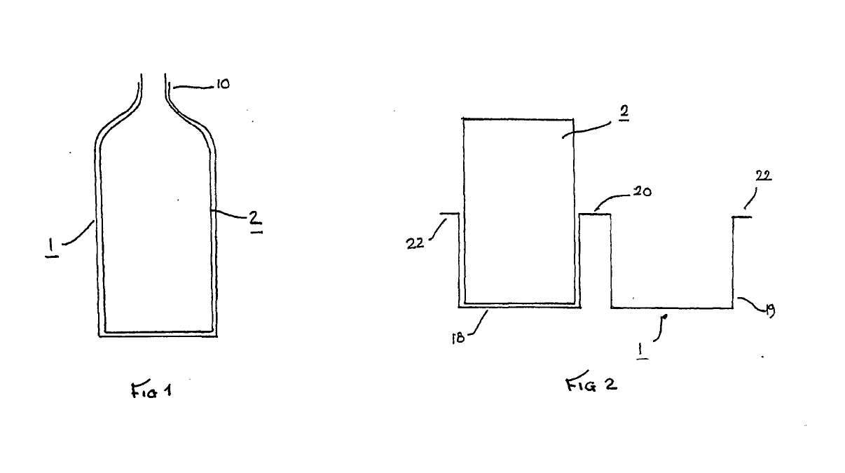

FIG. 1 shows an example of a container having an inner liner 2 and an outer shell 1.

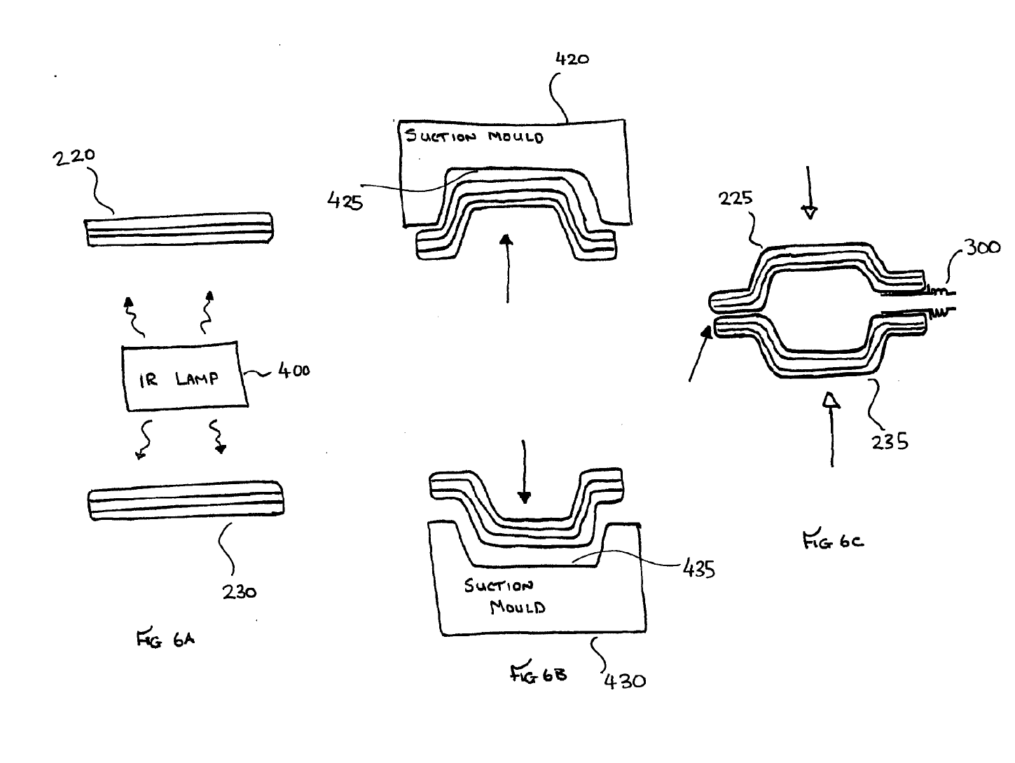

One example of a method of forming the inner liner 2 is described with respect to FIGS. 6A to 6C.

Two multilayer films 220, 230 are provided on either side of a heating means in the form of an infra-red (IR) lamp 400.

Each multilayer film 220; 230 is shown including three layers of laminated material, with each laminated material being provided to serve a specific function. For example, the multilayer films 220, 230 may each include two outer coating layers, for example of PE, LDPE or HDPE, sandwiching a barrier layer, for example including EVOH and/or aluminium. The overall thickness of the film 220; 230 may be around 50 to 100 microns, ideally 50 to 80 microns, with the barrier layer having a thickness of less than 10 microns, for example around 4 microns. It will be appreciated that more or fewer layers can be provided, and that the layers need not include a coating or barrier layer. In one example, a single layer film may be used.

The IR lamp 400 is activated to irradiate the films 220, 230 and thereby heat the films to a desired temperature. A suitable temperature is one lying between the slip point(s) and the melting point(s) of the layers.

As is shown in FIG. 6B, once the films 220, 230 have reached the desired temperature, they are vacuum formed, where each film 220; 230 is sucked against a mould surface 425; 435 to adopt a desired shape. The vacuum forming mould 420; 430 typically consists of a perforated and contoured moulding surface 425; 435 through which air is sucked, to draw the film onto the contoured surface, thereby causing the film 220; 230 to adopt a profile that generally conforms with the contoured surface 425; 435 of the tool 420; 430. The shape of the tool 420; 430, and therefore the shape of the formed liner 2, corresponds generally to the internal shape of the hollow shell 1.

As part of this vacuum forming process, the films 220, 230 become stretched and therefore the thickness of at least part of the films is reduced. The original film 220; 230 may have a thickness in the range of 50 to 80 microns, with the final liner 2 having a wall thickness of 25 to 50 microns.

Once the two films 220, 230 have been vacuum formed into desired shapes, they are allowed to cool and at least partially set into these desired shapes. This can be assisted by cooling the mould tool.

As shown in FIG. 6C and FIG. 8, an insert 300 in the form of a neck or collar portion is provided at one end between the two shaped portions of the liner 225, 235. A portion of the insert 370 in FIG. 6C extends beyond the periphery of the portions of the liner 225, 235, which portion 370 including a flange 350 and an external screw thread 375. The insert 300 also includes a portion 320 which is positioned between the two shaped portions of the liner 225, 235.

The shaped parts of the liner 225, 235 are brought together and sealed around their peripheral edges, such as by heat welding their edges together, to form the liner 2 having an internal volume. As part of this, the shaped portions of the liner 225, 235 are joined to the portion of the insert 320 extending between the portions of the liner 225, 235 to join the insert 300 to the portions of the liners 225, 235.

Any excess material, such as excess material along the joined periphery flanges or edges, can be cut or cropped off from the liner 2 which helps ensure that the liner 2 fits snugly when placed within the shell 1. In some examples, the flange along which the parts 225, 235 are joined has a dimension of around 4 mm.

The insert 300 positioned between the opposed portions of the liner 225, 235 forms a passageway between the internal volume of the liner and the external environment. This opening allows for contents to be filled into or dispensed from the internal volume of the liner. The flange 350 of the insert 300 is able to rest against or be joined to a portion of the hollow shell 1 to hold the collar or neck portion 300 in place with respect to the shell 1, and the external thread 375 can receive a screw cap to close the container. It will be appreciated that the flange 350 is not necessary, and any alternative features may be provided in place of or in addition to the external thread 375 for a suitable closure.

The insert 300 may alternatively be joined to one of the films either before or after this is joined to the other film.

Although it is described that the two parts of the liner 225, 235 are joined by welding, it will be appreciated that these could be joined in other ways, for example using an adhesive. Similarly, the insert 300 could be joined to the parts of the liner 225, 235 using an adhesive or other suitable attachment means. The insert 300 could be formed integrally with one or both parts of the liner 225, 235.

The liner 2 could be formed from a single film, or from more than two films. To form the liner 2 from a single film, the liner 2 can be formed in an open condition which is then folded and welded or otherwise joined along the seam to form the hollow shape required, or may be formed as a unitary hollow product.

Once the liner 2 has been formed, it is then positioned in an open shell 1, and the open shell is closed around the liner 2 to form the container. This can be seen from the alternative embodiments depicted by FIGS. 2 and 3, and FIGS. 4 and 5.

In FIG. 2, the open shell is provided in the form of a unitary item, which has portions—in this case, two portions 18, 19—that are foldable with respect to each other. The shell 1 is provided in an open condition, with the two parts 18, 19 of the finished product being formed side-by-side, and connected by a hinged portion 20 that extends along a longitudinal side of the final container. It will be appreciated that the hinged portion 20 could be formed elsewhere, for example along the bottom of the shell 1 or laterally along the side of the shell 1.

At least one part 18 of the open shell includes an extension tab or flange 22 which can be used in connecting the two parts of the shell 1 together.

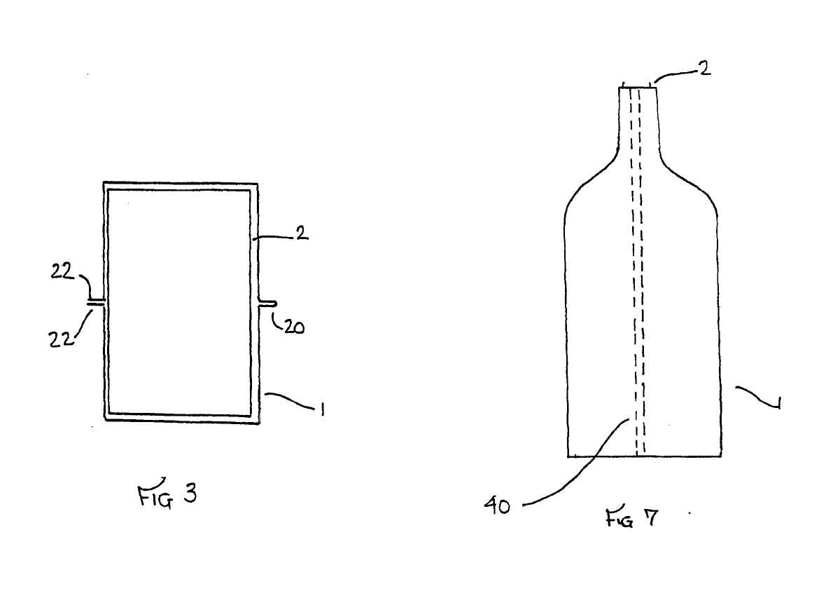

The liner 2 is positioned within one of the two parts 18 of the shell 1, and one or both parts of the shell 18, 19 is/are folded about the hinged portion 20, such that the open shell closes around the liner 2. The parts 18, 19 are then secured with respect to each other to form the container, for example by adhering the extension tabs or flanges 22 together. This is best shown in FIG. 3, where the two parts of the shell 18, 19 have been folded around the hinged portion 20, and where the free ends of the two components overlap and are joined by a suitable adhesive. It will be appreciated that the components can be attached by means other than an adhesive if required. For example, a label could be provided that extends over the join to fix the two parts together or the entire container could be shrink wrapped to hold it together. In this case, extension tabs may not be required. Alternatively, the shell 1 could be formed with extensions that connect without any additional means, for example by providing an interference fit, a tab and groove or other locking mechanism. It will be appreciated that even when the container is to hold a fluid, it is not necessary for the join to be fluid tight, since the contents are held within a bag provided within the shell 1.

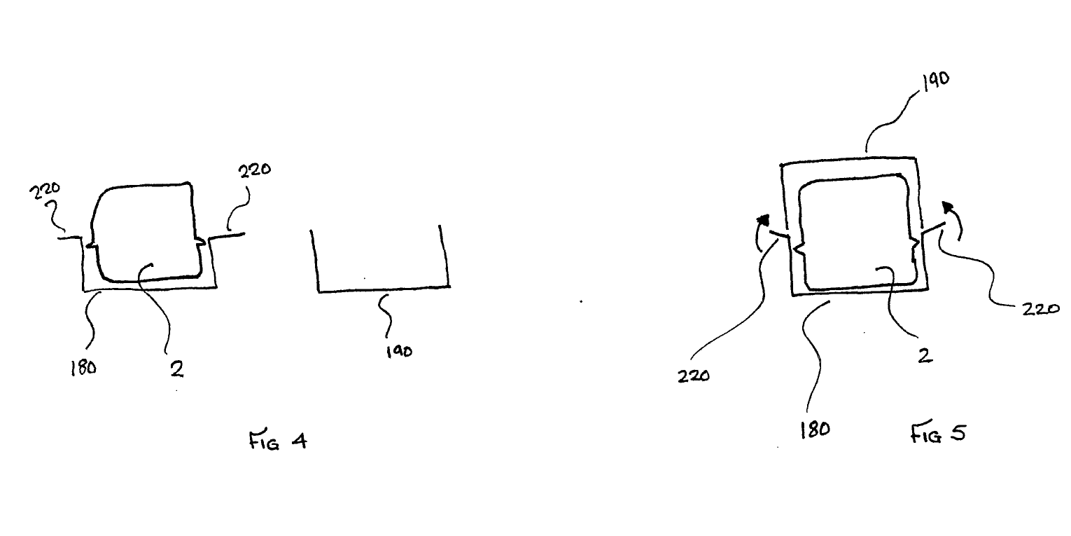

In the example of FIGS. 4 and 5, the open shell is formed as a number of separate parts, which are placed and joined together to form the finished, outer, shell 1. The open shell is formed of two parts 180, 190. The liner 2 is positioned in one of the parts 180, and the parts 180, 190 are moved together, and secured with respect to each other to close the shell 1 around the liner 2.

As shown in FIGS. 4 and 5, the parts of the open shell 180, 190 each include securing means in the form of one or more flanges 220 which are folded around the outer surface of an opposing part when the parts 180, 190 have been brought together, and adhered to the outer surface of that corresponding part to secure the parts together, for example using kit melt adhesive. Such securing of the parts 180, 190 together around the outside of the shell 1 after the shell has been closed ensures that the inner liner 2 will not come into contact with or be splashed by the adhesive. This is particularly relevant as contact between the hot adhesive and the liner 2 could melt or otherwise damage the liner 2, for example by tearing, puncturing or weakening portions of the liner 2. It will be appreciated that the flanges 220 in FIGS. 4 and 5 could be located on either or both parts of the shell. Arrangements such as those shown in FIGS. 4 and 5 will additionally provide a user with an easy and effective way to remove the liner 2 from the shell 1 after use. Clearly the shell 1 may be formed using more than two parts.

Alternatively, no flanges need be provided to connect the respective sections of the shell 1. Instead, a shrink wrapped moisture resistant coating can be formed on the outer surface of the container and this can act to hold the sections of the shell 1 together. It will be appreciated that the use of interlocking tabs, flanges for adhering or otherwise attaching parts of the shell together, adhesive labels and the wrapping of the outside of the shell are suitable means of assembling the shell 1 according to any aspect or example of the present invention, and any suitable attachment means may be used.

Where the liner 2 includes an insert 300 forming an opening, the insert 300 is arranged to extend beyond the outer surface of the hollow shell 1. Where the insert 300 includes a flange or similar projection 350, this can lie against a surface or ledge of the shell 1, for example the outer surface of the shell 1, to support the insert 300 with respect to the shell 1. The flange or similar projection 350 may be attached to the shell 1, for example using an adhesive. Where the insert 300 includes a mating feature, such as a screw thread 375, this can be used to mate with a closure, such as a screw cap, to close the container.

The outer shell 1 may be made from wood or paper pulp by moulding. For example, where the hollow shell 1 is formed from pulp, such as paper pulp, the pulp material can be diluted so that this can be a moulded. A mould is provided, typically in the form of a wire mesh, and the pulp is sprayed and/or sucked onto the surface of the mould, for example by applying a sucking force or vacuum. After moulding the component, the component is heated to evaporate the moisture, and solidify the shell 1.

Furthermore, by forming the shell 1 from wood or paper pulp, the shell can easily be disposed of, since this is a biodegradable, compostable and recyclable material. However, it will be appreciated that other materials may be used, which may or may not be recycled and/or biodegradable, and other formation techniques may be used. It is not necessary that the shell 1 is formed from biodegradable material, although this is clearly preferred.

Where the container is to include food or beverage, the liner 2 should include at least one layer that is of food standard. Many plastic films, including films of LDPE, LLDPE and HDPE films can be food standard. The film can include an accelerator to make it oxodegradable.

As an alternative to vacuum forming, the liner 2 could be formed by blow moulding. In this case, the material from which the liner 2 is formed is provided within a mould, and this is blown into contact with the inside of the mould to assume the desired shape. However, it is not expected that blow moulding of a liner 2 could provide as thin a liner 2 as could be obtained by vacuum forming a film and therefore vacuum forming is preferred. Where the liner 2 is formed by blow moulding, the thickness of the material forming the liner 2 is typically in excess of 300 microns.

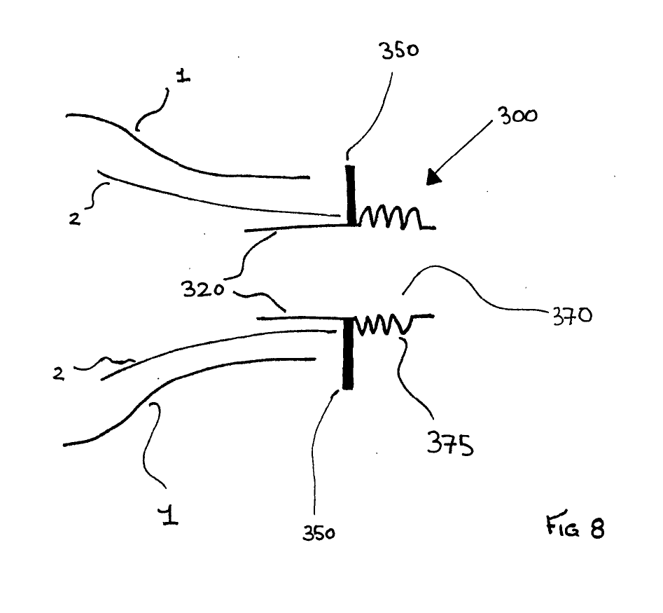

As shown in FIG. 7, the shell 1 may include a tear strip 40 along its length. By tearing the tear strip 40 along the perforations shown in FIG. 7, the shell 1 can be opened. In one example, the tear strip 40 is provided along the inner edge of the flanges 22 used to join the two parts of the shell 1, inboard of the join between the flanges 22. When the tear strip 40 is torn, the shell 1 may be opened, for example about the hinge 20, allowing access to the pre-formed liner 2 in the shell 1. The liner 2 may then be removed from the shell 1. In many cases, the shell 1 may be openable merely by shearing along the join between the two or more parts of the shell.

In use, the container can be filled with liquid or other product to be packaged by introducing this through a dispensing aperture of the outer shell 1 and passing this through an opening in the liner 2 and into the internal volume of the liner 2. The contents are then stored in the container until they are dispensed through the dispensing aperture. When all the contents have been dispensed, and it is desired to dispose of the package, the shell 1 can be opened using the tear strip 40, and the liner 2 removed from the shell 1.

In the preferred example, where the hollow shell 1 is formed from a compostable material, the shell 1 can be disposed of on a compost heap. The liner 2, which may not be formed of a biodegradable material, can be either recycled, or can at least be disposed of in the most suitable way for such a material. It would be appreciated that the liner 2 itself could be formed from a material that decomposes, and in this case this could also be disposed of on a compost heap. In this case, the advantage of removing the liner 2 from the container is that the two components can be disposed of in the most suitable way. A further advantage of the present invention is that the shell 1 can be formed from a non-food standard material, since the liner 2 separates the contents from the shell 1.

It will be appreciated that a tear strip 40 is not always required to allow access to the liner 2 after use of the container. For example, the shell 1 may be torn or cut and opened without the provision of any weakened portions.

Although, in some embodiments, the invention has been described with the shell 1 opened in two side by side components into which the liner 2 is provided before the two parts of the shell are folded with respect to each other to close the shell, it will be appreciated that the shell 1 could be assembled with one side or the bottom of the shell being opened such that the liner 2 can be slid into the shell through the opening. The shell 1 may include flaps that can then close the opening, or may include a separate component that is positioned over the opening to close the opening.

1. A method of forming a container comprising an inner liner and an outer shell, the method comprising:
providing an open shell that is closeable to provide the outer shell having an inner volume defined by the inner walls of the shell;
providing a film;
heating the film;
vacuum forming the film to form a liner having a shape conforming generally to at least a portion of the inner volume of the shell;
positioning the liner in the open shell; and
closing the shell around the formed liner.

2. The method of claim 1, wherein the film comprises two or more layers of material which are joined together.

3. The method of claim 2, wherein the multilayer film includes a barrier layer.

4. The method of claim 3, in which the barrier layer comprises or consists essentially of EVOH and/or aluminium.

5. The method of claim 1, wherein the step of providing an open shell includes providing portions of the shell in a unitary item, which can be folded with respect to each other to form the hollow shell.

6. The method of claim 1, wherein the step of providing an open shell includes providing multiple, separate, parts of the hollow shell which are closed by joining the parts together.

7. The method of claim 1, wherein the open shell includes one or more joining surfaces for connecting the parts of the shell together, the method further comprising applying adhesive to the one or more joining surfaces after closing the parts of the shell to join the parts of the shell.

8. The method of claim 1, in which the liner is positioned in the open shell such that a part of the liner will extend through a dispensing aperture of the shell when the open shell is closed.

9. The method of claim 1, including the step of forming the liner with a collar or neck portion.

10. The method of claim 9, wherein the collar or neck is formed as a separate component which is joined to the remainder of the liner.

11-13. (canceled)

14. The method of claim 1, in which each film is heated using radiation, such as infrared energy.

15. A container comprising an outer shell and an inner liner, the outer shell comprising an open shell that is closeable to provide the outer shell having an inner volume defined by the inner walls of the shell, and the inner liner comprising a vacuum formed liner formed from a film, the liner having a shape conforming generally to at least a portion of the inner volume of the shell.

16. The container of claim 15, wherein the liner is formed from a multilayer film comprising two or more layers of material.

17. The container of claim 16, wherein the liner includes a barrier layer.

18. The container of claim 17, wherein the liner comprises an outer coating comprising PE, LDPE or HDPE, and an inner the barrier layers that comprises or consists essentially of EVOH and/or aluminium.

19. The method of claim 10, wherein the collar or neck is joined to the remainder of the liner by welding or by an adhesive.

20. The method of claim 19, wherein the bottom of the shell is coated with water resistant material.

21. The method of claim 20, wherein the water resistant material is formed of PVA or latex.

22. The method of claim 1, wherein the shell includes an accelerator that helps promote degradation.

23. The method of claim 1, wherein the shell is provided with a moisture resistance covering on the outer surface.

24. The container of claim 15, wherein the shell includes an accelerator that helps promote degradation.

25. The container of claim 15, wherein the shell is provided with a moisture resistant covering on the outer surface.

26. The container of claim 15, wherein the bottom of the shell is coated with water resistant material.

27. The container of claim 15, wherein the water resistant material is formed of PVA or latex.
